(19) United States
(12) Patent Application Publication
(10) Pub. No.: US 2019/0212783 A1
(43) Pub. Date: Jul. 11, 2019

(54) FOOT FOR ELECTRONIC DEVICE, ELECTRONIC DEVICE INCLUDING THE FOOT AND METHOD OF MANUFACTURING THE FOOT

(71) Applicant: Yongheng Zhou, Guang Dong (CN)

(72) Inventor: Yongheng Zhou, Guang Dong (CN)

(21) Appl. No.: 16/306,201

(22) PCT Filed: Jun. 7, 2016
(86) PCT No.: PCT/CN2016/085124

§ 371 Date: Nov. 30, 2018

(51) Int. Cl. G06F 1/16

(52) U.S. Cl. CPC G06F 1/1656

(57) ABSTRACT

A foot (200A) of an electronic device includes a first member (220) and a second member (240). The first member (220) is in contact with a support surface when the electronic device is placed on the support surface. The second member (240) is engaged to the first member (220), and the second member (240) is in contact with a body of the electronic device at least when the foot (200A) is subjected to mechanical impact. The first member (220) has hardness greater than that of the second member (240).

### FIELD OF THE INVENTION

This disclosure relates to an electronic device, and more particularly to improvements in a foot of an electronic device.

### BACKGROUND OF THE INVENTION

For a consumer electronic device such as a laptop, a foot for supporting a body of the consumer electronic device may be provided. A soft foot can provide a good shock isolation effect, thereby facilitating shock absorption and further protecting inner components (e.g., a hard disk) of the electronic device when the electronic device is subjected to mechanical impact. However, the soft foot may be prone to abrasion. In contrast, a stiff foot may have an inferior shock absorption performance although with high abrasion resistance.

A foot made from a single material may be either soft or hard, and is therefore difficult to have good shock absorption and high abrasion resistance concurrently.

Therefore, there is a need to make an improvement on a foot of an electronic device to have reliable shock absorption and abrasion resistance concurrently.

Here, it should be noted that, the technical contents provided in this section are only for facilitating understanding of the present disclosure, but do not necessarily constitute the prior art.

### SUMMARY OF THE INVENTION

In a first aspect of the present disclosure, a foot for an electronic device is provided and includes a first member and a second member. The first member is configured to be fixed to the electronic device and adapted to be in contact with a support surface when the electronic device is placed on the support surface. The second member is engaged to the first member, and the second member is configured to be in contact with a body of the electronic device at least when the electronic device is subjected to mechanical impact, for example, being shocked or dropped. The first member is configured to have hardness greater than that of the second member.

In a second aspect of the present disclosure, an electronic device is provided and includes a body and a foot fixed to the body. The foot includes a first member and a second member. The first member is configured to be fixed to the body of the electronic device and adapted to be in contact with a support surface when the electronic device is placed on the support surface. The second member is engaged to the first member, and the second member is configured to be in contact with the body at least when the electronic device is subjected to mechanical impact. The first member is configured to have hardness greater than that of the second member.

In a third aspect of the present disclosure, a method of manufacturing a foot for an electronic device is provided. The foot includes a first member and a second member engaged to the first member. The first member is configured to be fixed to a body of the electronic device and adapted to be in contact with a support surface when the electronic device is placed on the support surface. The second member is configured to be in contact with the body of the electronic device at least when the electronic device is subjected to mechanical impact. The method includes steps of providing a first material for molding the first member and a second material for molding the second member, and molding the first member and the second member by a double injection molding process, wherein the first member has hardness greater than that of the second member.

### BRIEF DESCRIPTION OF THE DRAWINGS

Features and advantages of one or more embodiments of the present disclosure will be apparent from the following description with reference to the drawings in which:

FIG. 1 is a perspective view showing an electronic device according to one embodiment of the present disclosure;

FIG. 2 is a perspective view showing a foot according to an embodiment of the present disclosure;

FIG. 3 is a cross sectional view taken along Line III-III as indicated in FIG. 2 and showing the foot when attached to a body of the electronic device;

FIG. 4 is a cross sectional view taken along Line IV-IV as indicated in FIG. 2 and showing the foot when attached to the body of the electronic device;

FIG. 5 is a cross sectional view showing a second member with a rib variant having a trapezoidal-shaped cross section;

FIG. 6 is a cross sectional view showing a second member with a further rib variant having a triangular-shaped cross section

FIG. 7 is a perspective view showing a foot according to another embodiment of the present disclosure;

FIGS. 8 and 9 are perspective views showing the foot in FIG. 7 attached to a body;

FIGS. 10 and 11 are perspective views showing a foot according to a further another embodiment of the present disclosure;

FIG. 12 is a cross sectional view taken along Line X-X as indicated in FIG. 10 and showing the foot;

FIG. 13 is a cross sectional view taken along Line XI-XI as indicated in FIG. 10 and showing the foot fixed to a body;

FIG. 14 is a perspective view showing a foot according to a further more embodiment of the present disclosure; and

FIG. 15 is a cross sectional view taken along Line XIII-XIII as indicated in FIG. 14 and showing the foot.

### DETAILED DESCRIPTION

Now the present disclosure is described in detail by means of exemplary embodiments and with reference to the drawings. The following detailed description of the present disclosure is only illustrative rather than a limitation to the present disclosure and application or usage thereof.

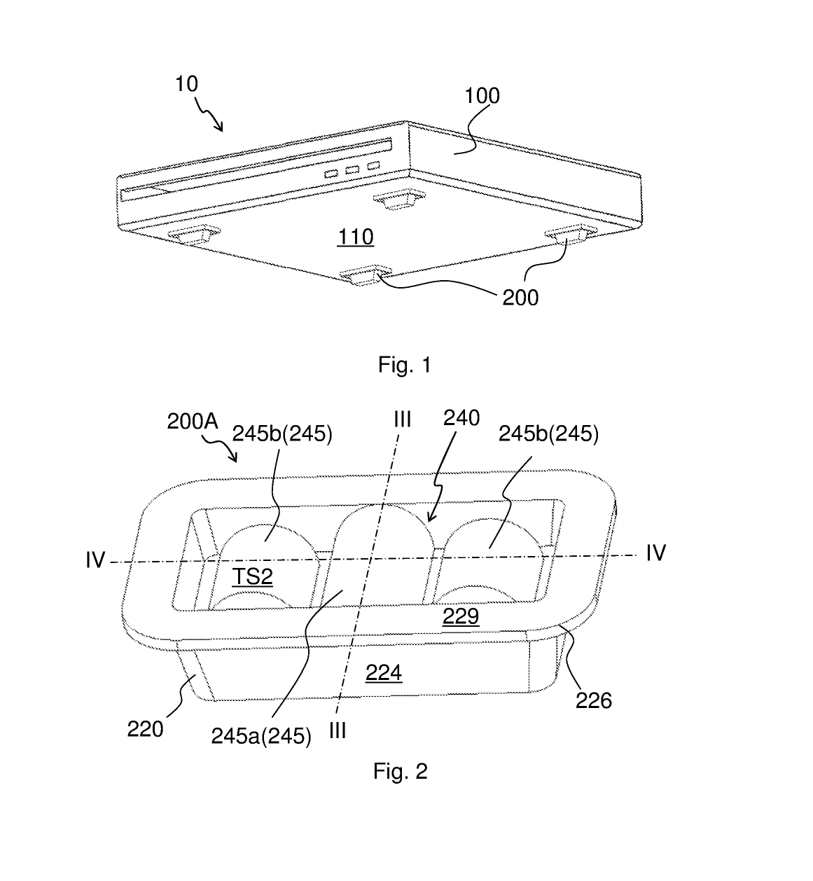

According to an embodiment of the present disclosure, referring to FIG. 1, an electronic device 10 is provided and includes a body 100 and at least one foot 200. The body 100 includes a bottom 110, and the foot 200 is fixed to the bottom 110. The foot 200 is adapted to stand on a support surface and support the body 100 when the electronic device 10 is placed on the support surface. The electronic device 10 may be a consumer electronic device such as a laptop or a tablet computer. The consumer electronic device typically has therein some internal components, such as a hard disk, which may be easy to be damaged when the electronic device is subjected to mechanical impact. However, it is to be understood that the electronic device 10 according to the present disclosure may also be other types of electronic device.

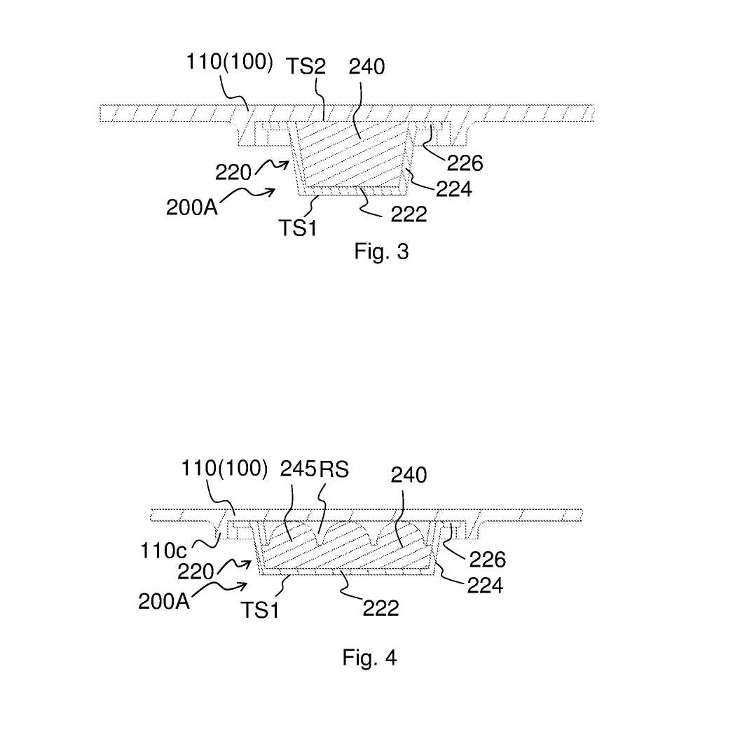

According to an embodiment of the present disclosure, a foot 200A is illustrated hereinafter with reference to FIGS. 2 to 4. The foot 200A includes a first member 220 and a second member 240. The first member 220 is adapted to be in contact with a support surface, for example, a desktop or ground, when the electronic device 10 is placed on the support surface. Alternatively, the first member 220 is configured further to be fixed to the electronic device 10, specifically to the bottom 110. The second member 240 is engaged to the first member 220. The second member 240 is configured to be in contact with the bottom 110 at least when the electronic device 100 is subjected to mechanical impact, for example, when the electronic device falls onto a desktop or ground. In a normal state where the electronic device is not subjected to mechanical impact, the second member 240 may be in contact with the body 100 or alternatively may be not in contact with the body 100.

Referring to FIGS. 2 and 4, the first member 220 includes a bottom wall 222, a circumferential wall 224 and a receiving space RS defined by the bottom wall 222 and the circumferential wall 224. The second member 240 is located between the first member and the body of the electronic device, specifically in this embodiment, is located in the receiving space RS. In this way, the foot 200A may be conveniently made, and the second member 240 can be stably positioned in the first member 220 and can be prevented from being exposed to the outside to affect the aesthetic appearance.

The first member 220 alternatively includes a flange 226 at one side of the circumferential wall 224 opposite to the bottom wall 222 as shown in FIG. 2 and the flange 226 is adapted to be fixed to the bottom 110 of the electronic device 10. Alternatively, an adhesive layer 229, e.g., PSA, i.e., a pressure-sensitive adhesive layer, is provided on the flange 226, and the first member 220 and thus the whole foot 200A can be fixed to the body 100 of the electronic device 10 by the adhesive layer 229. In this way, the foot 200A can be fixed to the body 100 in a relatively simple manner.

Referring to FIG. 2, the second member 240 includes a contact surface TS2 adapted to be in contact with the body 100 of the electronic device 10, specifically adapted to be in contact with the bottom 110. Preferably, at least portion of the contact surface TS2 of the second member 240 is not lower than the flange 226, thus the second member 240 can be in contact with and support the body 100 of the electronic device 10 when the electronic device 10 is subjected to mechanical impact. Consequently, the second member 240 can provide shock absorption.

The foot 200A is configured such that the hardness of the first member 220 is greater than the hardness of the second member 240. Thus, the second member 240 is comparatively soft and therefore is capable of providing a good shock isolation or absorption effect, and meanwhile the first member 220 is comparatively stiff and therefore can have a high abrasion resistance. By this way, the foot 200A as a whole has the desired effect in both shock absorption and abrasion resistance, and thus is able to address the issue of insufficient shock absorption and the issue of severe abrasion in some of existing foots used for the electronic devices.

The hardness of the first member 220 can be about 70 HA (Shore A) or higher, preferably ranging from 70 HA to 120 HA, more preferably ranging from 80 HA to 100 HA, and further more preferably ranging from 85 HA to 95 HA.

The hardness of the second member 240 can be 60 HA or lower, preferably ranging from 25 HA to 55 HA, more preferably ranging from 45 HA to 55 HA, and further more preferably about 50 HA.

A hardness difference between the first member 220 and the second member 240 can be about 15 HA or larger, preferably ranging from 15 HA to 95 HA, more preferably ranging from 25 HA to 55 HA, and further more preferably ranging from 35 HA to 45 HA.

The hardness of the first member 220 and the second member 240 may be selected such as to allow the first member 220 to address the issue of abrasion and allow the second member 240 to have a good compression property and a good elasticity, thereby addressing the issue of buffering (e.g. mechanical impact and shock absorption). By making each of the first member 220 and the second member 240 have an appropriate hardness and/or by making the first member 220 and the second member 240 have an appropriate hardness difference, the foot 200A as a whole can gain the desired effects in both shock absorption and abrasion resistance.

In some examples, the first member 220 and the second member 240 can be made from different materials. In other examples, the first member 220 and the second member 240 can be made from the same kind of material but having different hardness. For example, TPE (thermoplastic elastomer) may be manufactured to have a hardness ranging from 40 HA to 88 HA. Thus, the first member 220 can be made of TPE with a hardness larger than 70 HA, while the second member 240 can be made of TPE with a hardness less than 55 HA.

Alternatively, the first member 220 can be made from one or more materials selected from the group including: TPE (thermoplastic elastomer), TPU (thermoplastic polyurethane elastomer), silicone rubber, EPDM (ethylene propylene diene monomer), PC (polycarbonate), PC/ABS (a mixture of polycarbonate and acrylonitrile-butadiene-styrene), glass fiber reinforced polycarbonate, PET (polyethylene terephthalate) and a metallic foil. The second member 240 can be made from one or more materials selected from the group including: TPE, TPU, silicone rubber, EPDM and foam. However, it should be understood that the material for the foot 200A is not limited to the above materials, and may also be other suitable materials.

The first member 220 and the second member 240 can be integrally formed by a double injection molding process. Alternatively, the first member 220 and the second member 240 can be separately formed and then assembled together. Alternatively, a first material for making the first member 220 and a second material for making the second member 240 can be appropriately selected so as to allow the first member 220 and the second member 240 to be naturally integrated together by the injection molding, thus the first member 220 and the second member 240 can be integrally formed without additionally connecting component, for example, by applying an adhesive.

Alternatively, the first member 220 having a greater hardness may further have a greater stiffness while the second member 240 having a smaller hardness may further have a smaller stiffness, which can be achieved by designing the structure of the first member 220 and the second member 240 respectively, thus further improving abrasion resistance or anti-abrasion and facilitating absorption of mechanical shock or impact.

As shown in FIG. 2, the contact surface TS2 of the second member 240 may be provided with one or more ribs (buffering ribs) 245. With the ribs 245, the stiffness of the second member 240 can be advantageously determined by changing the shape and cross sectional area of the second member 240 and thus the desired shock absorption effect of the second member 240 can be achieved accordingly. In other examples, the contact surface TS2 of the second member 240 can be a flat surface, or the contact surface TS2 of the second member 240 can be provided with one or more protrusions.

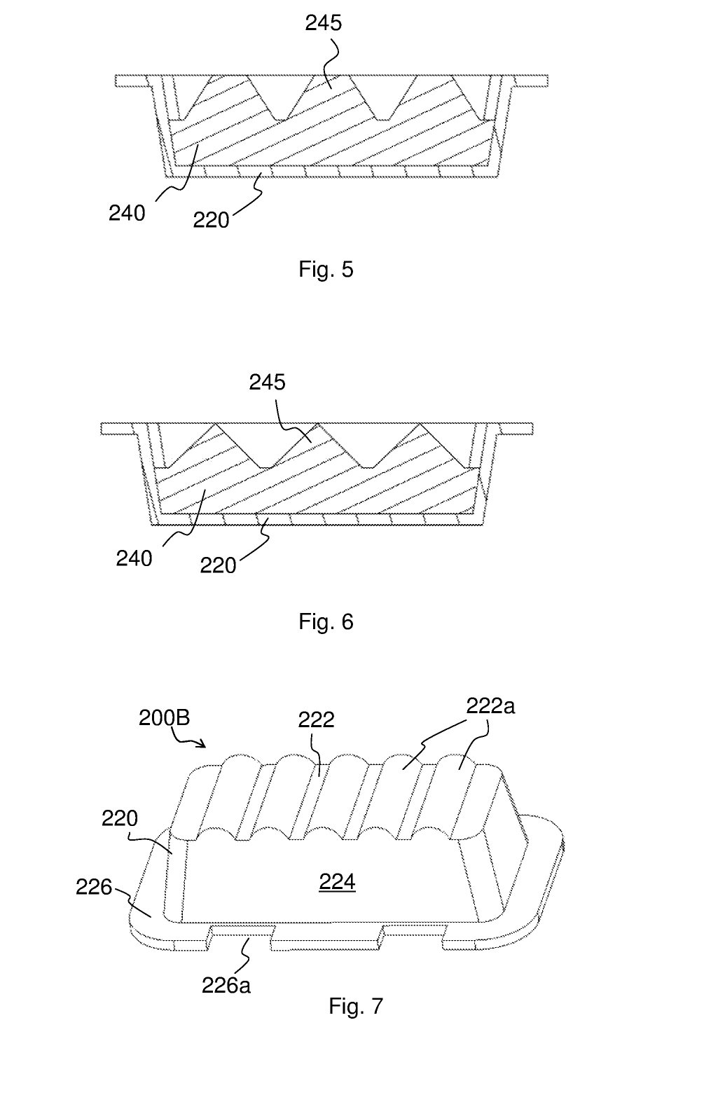

For the case where the contact surface TS2 is provided with multiple ribs 245, among the multiple ribs 245, a rib 245a in the middle may be configured to have a greater length and/or height as compared with ribs on both sides 245b (referring to FIG. 2). In this way, the stiffness of the second member 240 may be further advantageously determined. Alternatively, for the case where the contact surface TS2 is provided with one or more ribs 245, the cross section of the rib 245 may have a circular arc shape (as shown in FIG. 4), or the cross section of the rib 245 may have other suitable shapes, for example, a trapezoidal shape (as shown in FIG. 5) and a triangular shape (as shown in FIG. 6). In this way, the stiffness of the second member 240 may also be further advantageously designed.

Referring to FIG. 4, the first member 220 includes a contact surface TS1 adapted to be in contact with a support surface when the electronic device is placed on the support surface. As shown in FIG. 4, the contact surface TS1 of the first member 220 can be a flat surface. In other examples, the contact surface TS1 of the first member 220 can be provided with one or more ribs 222a as shown in FIG. 7, or can be provided with one or more protrusions (not illustrated). Thus, the stiffness of the first member 220 can be flexibly designed as desired, and the desired abrasion resistance of the first member 220 can be achieved accordingly, furthermore a sliding prevention effect may also be achieved.

The first member 220 can be configured to have an appropriate stiffness and an appropriate deformation factor, for example, alternatively by thinning the bottom wall 222 and the circumferential wall 224 of the first member 220 and/or by providing one or more holes in the bottom wall 222 and the circumferential wall 224.

The first member 220 can be configured to have a comparatively larger hardness by selecting proper material and further have a comparatively larger stiffness by designing its structure so as to ensure a high abrasion resistance. While, the second member 240 can be configured to have a comparatively smaller hardness by selecting proper material and further have a comparatively small stiffness by designing its structure so as to ensure a sufficient shock absorption effect. Thereby, the first member 220, by appropriate deformation, can effectively transmit the mechanical impact to the second member 240, thus to allow most of the mechanical impact to be absorbed by the second member 240. Consequently, a sufficient shock absorption effect and high abrasion resistance are achieved.

In sum, the foot 200A is configured by the stiff first member 220 as outside jacket and the soft second member 240 as inner core, and the first member 220 and the second member 240 are configured to have an appropriate hardness and/or stiffness respectively. Therefore, as compared with the existing foots in the art, the foot 200A according to the embodiments of the present invention can be good at both shock absorption and abrasion resistance in a simple and reliable way.

In this regard, the inventor performed the following comparison test.

Sample I was made according to the embodiment of the present disclosure as shown in FIG. 2, and its first member 220 is a plate-shaped stiff member with a dimension of 6*12*0.5 mm, its second member 240 includes a plate-shaped soft member with a dimension of 6*12*2 mm and three juxtaposed soft ribs having a triangular-shaped cross section with the dimension of each rib of 6*4*2 mm. Sample II is a single layered plate-shaped stiff member with a dimension of 6*12*5 mm. Sample III includes an outer layer of a plate-shaped stiff member with a dimension of 6*12*3 mm and an inner layer including three juxtaposed stiff ribs having a triangular-shaped cross section with the dimension of each rib 6*4*2 mm.

For each type of sample, an electronic device was provided with a weight of 2 Kg, and three samples were mounted on the electronic device for the test respectively. Further, a mechanical impact input of 140G/2 ms was employed during the test.

The test results are shown in the following table.

| | | Input | | Output | | |
|---|---|---|---|---|---|---|
| | | Acceleration | Duration | Acceleration | Duration | Transmission Rate |
| Sample | | (G) | (ms) | (G) | (ms) | (Output/Input) |
| Sample | 1 | 145 | 1.92 | 125 | 2.78 | |
| I | 2 | 145 | 1.92 | 128 | 2.72 | |
| | 3 | 145 | 1.86 | 132 | 2.68 | |
| | Average | 145 | 1.90 | 128 | 2.73 | 0.89 |
| Sample | 1 | 138 | 2.00 | 189 | 1.88 | |
| II | 2 | 142 | 1.96 | 189 | 1.90 | |
| | 3 | 145 | 1.96 | 193 | 1.90 | |
| | Average | 142 | 1.97 | 190 | 1.89 | 1.34 |
| Sample | 1 | 139 | 1.96 | 167 | 2.10 | |
| III | 2 | 141 | 1.94 | 165 | 2.12 | |
| | 3 | 141 | 1.92 | 170 | 2.08 | |
| | Average | 140 | 1.94 | 167 | 2.10 | 1.19 |

As can be observed in the above table, an average value of impact (represented by acceleration of gravity G) subjected by the electronic device in which Sample I was mounted is 128 as compared with an average value 190 of Sample II and an average value 167 of Sample III. The smaller the value is, the smaller the impact is subjected by the body of the electronic device such as the hard disk. Therefore, as compared with Sample II and Sample III, the shock absorption performance of Sample I corresponding to the foot according to the present disclosure can be improved by about 23%. In addition, in view of the impact transmission rate, Sample I is 0.89, which is also much lower than 1.34 of Sample II and 1.19 of Sample III. Furthermore, in an abrasion resistance test, Sample I had substantially the same abrasion resistance as Sample II and Sample III.

A foot 200B according to a second embodiment of the present disclosure is described hereinafter with reference to FIGS. 7 to 9. For concision, only different aspects of the foot 200B according to the second embodiment of the present disclosure from the foot 200A according to the first embodiment of the present disclosure are described hereinafter.

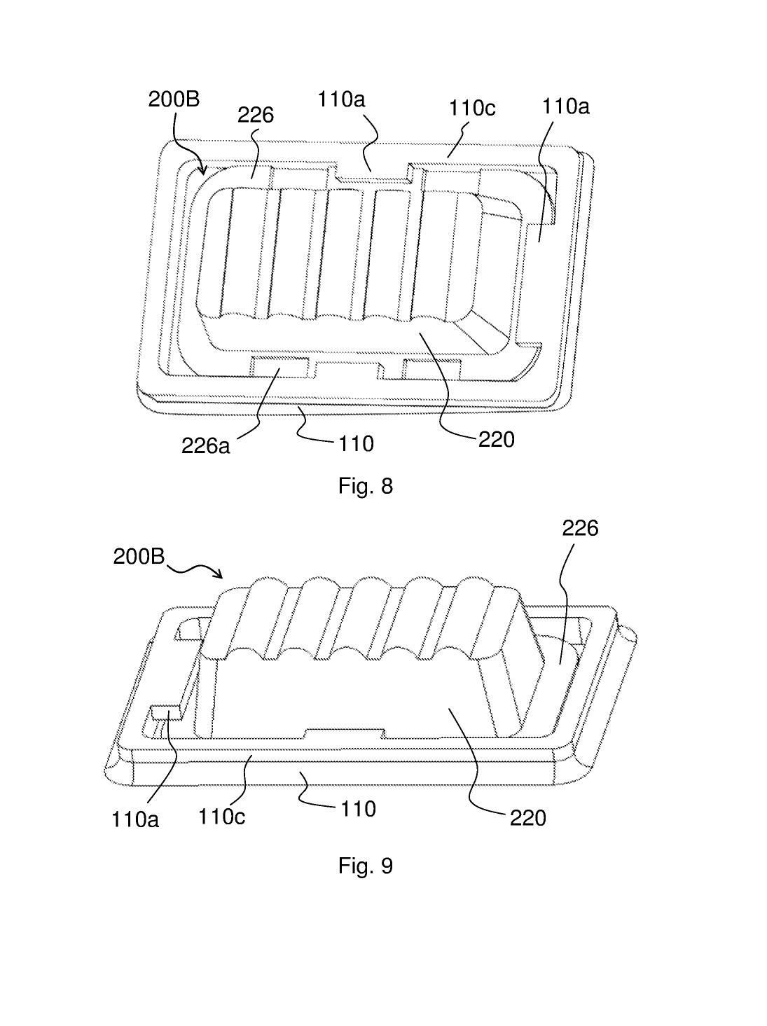

According to another embodiment of the present disclosure, as shown in FIGS. 8 and 9, the flange 226 is engaged with an engaging unit, which for example includes one or more tab 110a, provided at the bottom 110 of the body 100 of the electronic device 10, by which the first member 220 is fixed to the body 100 of the electronic device 10. As shown in FIG. 8, three tabs 110a are provided. Particularly, when a skirt 110c is provided at the bottom 110 of the body 100 of the electronic device 10, the tab 110a extends inward from a distal end of the skirt 110c so as to be adapted to be engaged with the flange 226 to restrict the first member 220 from being disengaged from the body 100 of the electronic device 10.

In a preferred example, one or more cutouts 226a are provided on the flange 226. With the cutouts 226a, the stiffness of the first member 220 can be adjusted, thus facilitating transmission of the mechanical impact load by the first member 220 to the second member 240 and facilitating attachment of the foot 200B to the body 100.

When the foot 200B is to be fixed to the body 100, as shown in FIG. 8, a step may include inserting the flange 226 of the first member 220 into an engagement groove defined by the tab 110a and the bottom 110, and sliding the foot 200B rightward in a state where the foot 200B (in particular, the first member 220) is deformed, thus the foot 200B can be fixed to the body 100. Here, in the case where the flange 226 is provided with the cutouts 226a, by passing a pair of upper and lower tabs 110a through the right cutout 226a of the flange 226, and then sliding the foot 200B rightward, the foot 200B can be more conveniently fixed to the body 100. For the foot 200B, a mechanical engagement manner instead of an adhesive manner is taken to achieve a more reliable attachment of the foot 200B to the body 100.

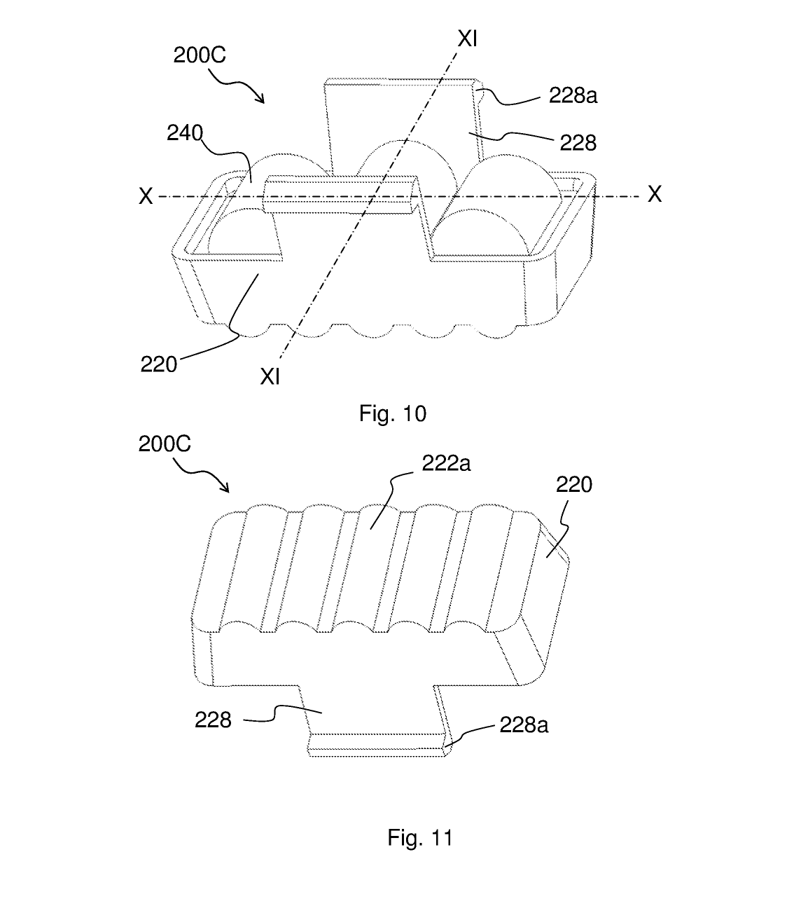

A foot 200C according to a further embodiment of the present disclosure is described with reference to FIGS. 10 to 13. Here different aspects of the foot 200C from the feet 200A, 200B according to the above mentioned embodiments of the present disclosure are described hereinafter.

The first member 220 of the foot 200C is provided with a pair of hooked arms 228 extending from a distal end of the circumferential wall 224 and adapted to be hooked into the body 100, in particular, the bottom 110, of the electronic device 10. The hooked arm 228 includes a hook 228a. Correspondingly, as shown in FIG. 13, two slots 110b are provided at the bottom 110 of the body 100 of the electronic device 10. When mounting the foot 200C, by for example clamping the hooked arms 228, the hooked arms 228 are slightly elastically deformed and the hook 228a is allowed to pass through one slot 110b smoothly. After the hook 228a passes through the slot 110b, the hooked arms 228 are elastically restored to allow the hook 228a to be hooked into the slot 110b. Alternatively, the hook 228a can be inserted through the slot 110b and snapped with an edge portion of the slot 110b of the bottom 110 of the body 100 of the electronic device 10.

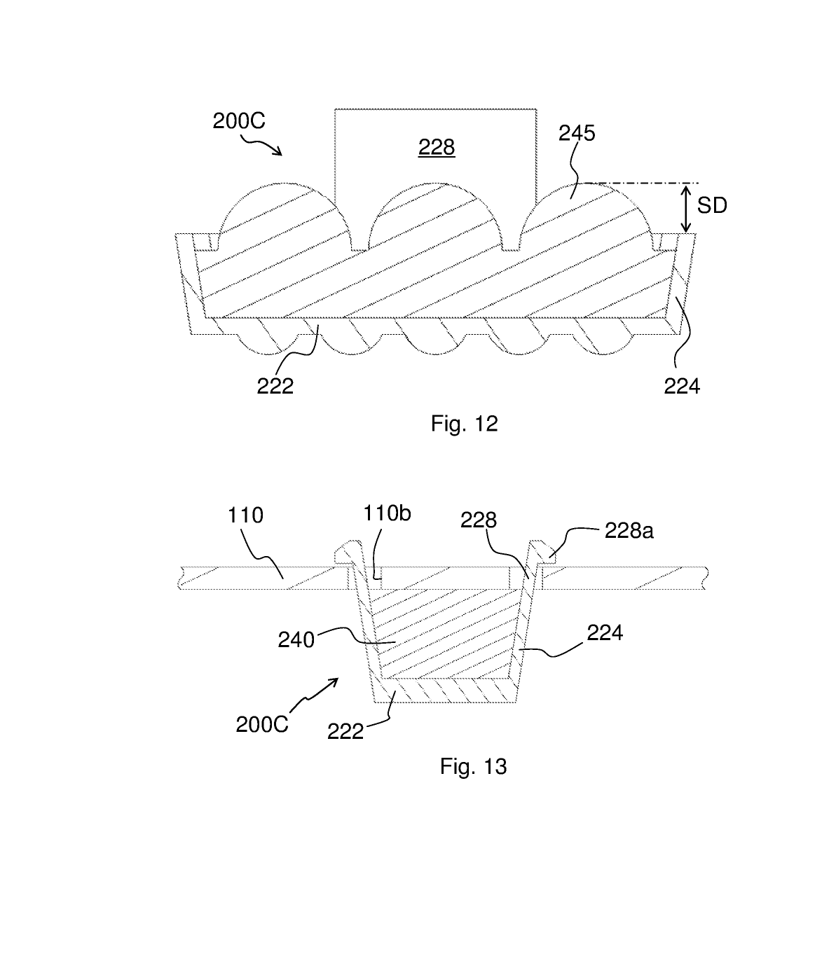

Further, with reference to FIG. 12, the second member 240 may extend beyond the distal end of the circumferential wall 224, thus forming a swaying distance SD (also called as “sway space”) for absorbing mechanical impacts.

By adopting the hook structure and by providing the swaying distance SD, on the one hand, the first member 220 is restricted from being disengaged from the body 100 of the electronic device 10, and on the other hand, when the foot 200C is subjected to mechanical impact, the foot 200C, in particular, the first member 220, is allowed to move inward while the second member 240 is in contact with the bottom 110 and compressed. Thereby, the impact load may be more effectively transmitted from the first member 220 to the second member 240 and is prevented as much as possible from being directly transmitted from the first member 220 to the body 100, and therefore a better shock absorption performance can be provided.

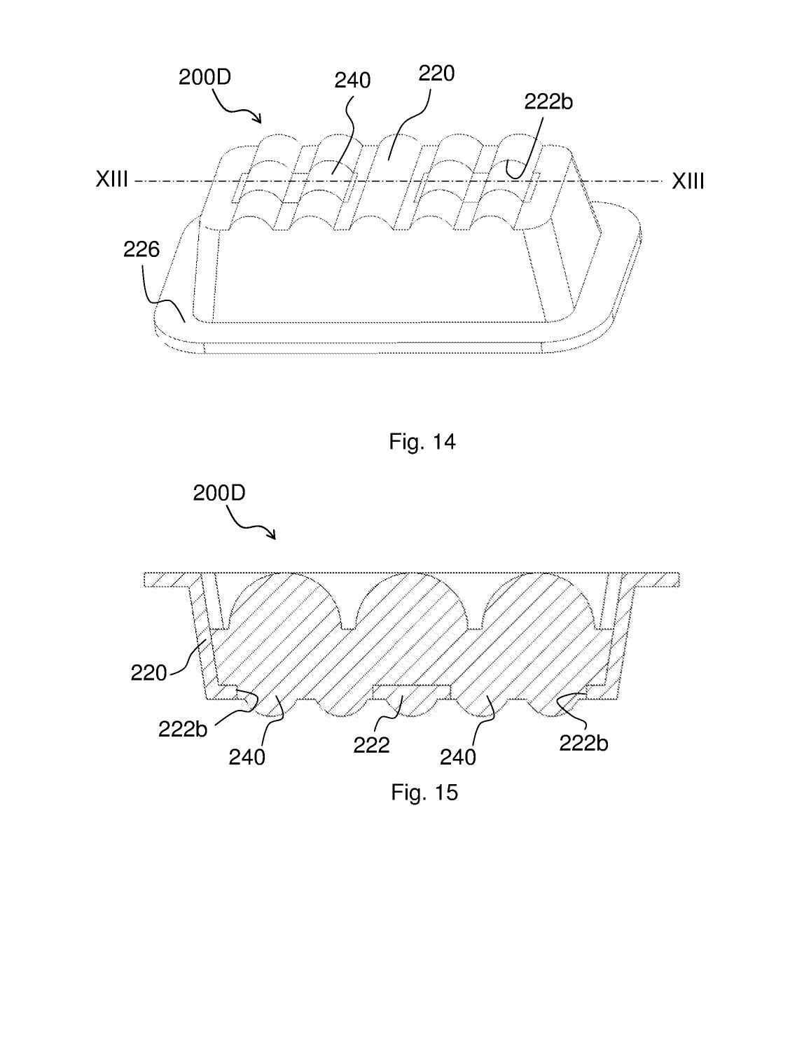

A foot 200D according to a further embodiment of the present disclosure is described with reference to FIGS. 14 and 15. Main different aspects of the foot 200D from the feet 200A-200C according to the above mentioned embodiments of the present disclosure are described hereinafter.

For foot 200D, One or more holes 222b are provided in the bottom wall 222 of the first member 220 adapted to be in contact with the support surface, a portion of the second member 240 may occupy the hole 222b and be exposed via the hole 222b. The exposed portion of the second member 240 may be in contact with the support surface, or alternatively may be concaved inward and not in contact with the support surface.

For the foot 200D, since its first member 220 is provided with the holes 222b occupied by the second member 240, the stiffness and the deformability of the first member 220 can be further designed.

Further, embodiments of the present disclosure also disclose a method of manufacturing the above-described foot 200.

First, a first material for molding the first member 220 and a second material for molding the second member 240 are provided respectively, and then, the first member 220 and the second member 240 are molded by a double injection molding process, so as to allow the first member 220 to have hardness greater than that of the second member 240.

In a preferred example, the first material and the second material are selected so as to allow the first member 220 and the second member 240 to be integrally formed by the double injection molding process. Alternatively, the first member 220 and the second member 240 can be naturally integrated together by the injection molding, so as to assemble the first member 220 and the second member 240 without additionally applying an adhesive.

In a preferred example, the first member 220 is firstly molded, and then in the same machine, the second member 240 is molded over the molded first member 220 by another mould.

The foot according to the present disclosure allows for various variations. For example, instead of the first member being connected to the body, the second member may be connected to the body so as to have the foot attached to the body. In this case, for example, an adhesive may be used to connect the second member to the body, and/or the first member can be formed into a plate-shaped body, instead of a grooved body, which is not in contact with the body.

It will be apparent to those skilled in the art that the specific exemplary structures, features, details, configurations, etc. that are disclosed herein can be modified and/or combined in numerous embodiments. All such variations and combinations are contemplated by the inventor as being within the bounds of the conceived disclosure not merely those representative designs that were chosen to serve as exemplary illustrations. Thus, the scope of the present disclosure should not be limited to the specific illustrative structures described herein, but rather extends at least to the structures described by the language of the claims, and the equivalents of those structures.

1. A foot for an electronic device, the foot comprising:
a first member adapted to be in contact with a support surface when the electronic device is placed on the support surface; and
a second member engaged to the first member and adapted to be in contact with a body of the electronic device at least when the electronic device is subjected to mechanical impact;
wherein the first member has hardness greater than that of the second member.

2. The foot of claim 1, wherein the second member is located between the first member and the body of the electronic device.

3. The foot of claim 1, wherein the first member has stiffness higher than that of the second member.

4. The foot of claim 1, wherein the hardness of the first member is 70 Shore A or higher and the hardness of the second member is 55 Shore A or lower.

5. The foot of claim 1, wherein a hardness difference between the first member and the second member is 15 Shore A or larger.

6. The foot of claim 1, wherein:
the first member is made from one or more materials selected from the group including: thermoplastic elastomer (TPE), thermoplastic polyurethane elastomer (TPU), silicone rubber, ethylene propylene diene monomer (EPDM), polycarbonate (PC), a mixture of polycarbonate and acrylonitrile-butadiene-styrene (PC/ABS), glass fiber reinforced polycarbonate, polyethylene terephthalate (PET) and a metallic foil; and/or
the second member is made from one or more materials selected from the group including: thermoplastic elastomer (TPE), thermoplastic polyurethane elastomer (TPU), silicone rubber, ethylene propylene diene monomer (EPDM) and foam.

7. The foot of claim 1, wherein the first member and the second member are integrally formed by a double injection molding process, or the first member and the second member are separately formed.

8. The foot of claim 1, wherein:
the first member comprises a contact surface adapted to be in contact with the support surface, the contact surface of the first member is a flat surface or is provided with at least one ribs or protrusions; and/or
the second member comprises a contact surface adapted to be in contact with the body of the electronic device, and the contact surface of the second member is a flat surface or is provided with at least one ribs or protrusions.

9. The foot of claim 8, wherein the contact surface of the second member is provided with a plurality of ribs, among the plurality of ribs a rib in the middle has a greater length and/or height as compared with ribs on both sides.

10. The foot of claim 1, wherein the first member comprises a bottom wall, a circumferential wall and a receiving space defined by the bottom wall and the circumferential wall, and the second member is located in the receiving space.

11. The foot of claim 10, wherein the first member is provided at the circumferential wall with a flange adapted to be fixed to the body of the electronic device.

12. The foot of claim 11, wherein one or more cutouts are provided on the flange.

13. The foot of claim 10, wherein the first member is provided with a hooked arm extending from the circumferential wall and adapted to be hooked into a slot provided at the body of the electronic device.

14. The foot of claim 11, wherein the second member comprises a contact surface and at least portion of the contact surface is not lower than the flange.

15. The foot of claim 11, wherein an adhesive layer is provided on the flange.

16. The foot of claim 10, wherein one or more holes are provided in the bottom wall and occupied by a portion of the second member.

17. An electronic device, comprising:
a body; and
at least one foot fixed to the body,
wherein the foot comprises:
a first member adapted to be in contact with a support surface when the electronic device is placed on the support surface; and
a second member engaged to the first member and adapted to be in contact with the body at least when the foot is subjected to mechanical impact,
wherein the first member has hardness greater than that of the second member.

18. The electronic device of claim 17, wherein the first member is provided with a flange adapted to be adhered to the body or adapted to be engaged with a corresponding member provided on the body.

19. The electronic device of claim 17, wherein the first member is provided with a hooked arm adapted to be hooked into a slot provided on the body.

20. A method of manufacturing a foot for an electronic device, wherein the foot comprises a first member adapted to be in contact with a support surface when the electronic device is placed on the support surface, and a second member engaged to the first member and adapted to be in contact with a body of the electronic device at least when the foot is subjected to mechanical impact,
wherein the method comprises steps of:
providing a first material for molding the first member and a second material for molding the second member; and
molding the first member and the second member by a double injection molding process, the first member having hardness greater than that of the second member.

21-22. (canceled)
